(19) United States
(12) Patent Application Publication
(10) Pub. No.: US 2019/0025516 A1
(43) Pub. Date: Jan. 24, 2019

(54) OPTICAL FIBER INLINE SPLICE ASSEMBLIES

(71) Applicant: AFL TELECOMMUNICATION LLC, Duncan, SC (US)

(72) Inventors: Ted Lichoulas, Simpsonville, SC (US); Eddie Kimbrell, Dacula, GA (US)

(21) Appl. No.: 16/069,748

(22) PCT Filed: Jul. 12, 2016
(86) PCT No.: PCT/US2016/041835

§ 371 Date: Jul. 12, 2018

Related U.S. Application Data
(60) Provisional application No. 62/280,912, filed on Jan. 20, 2016.

(51) Int. Cl. G02B 6/255; G02B 6/42; G02B 6/44; G02B 6/26; G02B 6/38; G02B 6/40

(52) U.S. Cl. CPC G02B 6/2558; G02B 6/4285; G02B 6/40; G02B 6/26; G02B 6/38; G02B 6/4403

(57) ABSTRACT

An optical fiber inline splice assembly includes a first optical fiber cable, the first optical fiber cable including a first optical fiber having a first end, and a second optical fiber cable, the second optical fiber cable including a second optical fiber having a second end, wherein the first end and second end are optically spliced together. The optical fiber inline splice assembly further includes a splice sleeve assembly, the splice sleeve assembly including a base and a lid mated with each other, the first end and the second end disposed within the splice sleeve assembly between the base and the lid, the splice sleeve assembly further including a first end connector and a second end connector, the first end connector and second end connector removably attached to the base and the lid to secure the first end and the second end within the splice sleeve assembly between the base and the lid.

### PRIORITY STATEMENT

The present application claims priority to U.S. Provisional Patent Application Ser. No. 62/280,912, filed Jan. 20, 2016 and which is incorporated by reference herein in its entirety.

### FIELD OF THE INVENTION

The present disclosure relates generally to fiber optic interconnections with electronic hardware. More particularly, the present invention relates to an optical fiber splice assembly which may be used for interconnecting a fiber optic cable with a pigtail of a transceiver module.

### BACKGROUND OF THE INVENTION

In the data center and high performance computing market, there has been growing demand for high data transfer rate and increased bandwidth. This market demand has resulted in a technological transition from copper to fiber optic transceivers (combined transmitters and receivers), including the implementation of on-board optics and fiber optic backplane connectivity.

Currently, most fiber optic transceiver modules are configured with either bulkheads or fixed length pigtails. In order to reduce overall system cost and link loss, there is a trend among system and module manufacturers to configure transceiver modules with pigtails with lengths ranging from 1 meter to 30 meters. Although this connectivity is advantageous for the end-user, integrating long pigtails into a transceiver module can be difficult in manufacturing and results in inventory management challenges for the manufacturer.

Currently, there are two main approaches. One approach is to build transceivers with discrete pigtails having lengths from 1 meter to 30 meters. This approach requires the manufacturer to stock cable assemblies with discrete lengths from 1 meter to 30 meters with a fiber optic connector, such as an MPO on one end and a v-groove block or lensed connector, such as a PRIZM-LT, on the other end. The manufacture will then attach the cable assembly v-groove block or lensed connector onto the optical engine of the module PCB while managing these variable length cable assemblies. This requires the manufacturer to develop complex handling and assembly fixtures that can compactly store these variable length cable assemblies during the manufacturing process. Additionally, the manufacturer must stock transceiver modules with multiple pigtail lengths to meet an unknown customer demand.

The second approach is to build transceivers with a 1 meter cable stub. The manufacturer would then splice the pigtail of required length onto the 1 meter stub of the transceiver. This approach simplifies the module manufacturing process and reduces the manufacturer's inventory risk. However, this approach also requires the manufacturer to build up a protective cover over the splice point. In particular, commercially available in-line splices typically have an outer diameter that is much larger than the cables they are joining (greater than 6 mm for a 3 mm outer diameter cable) and have a stiff length greater than 100 mm. The size of these inline splices makes it challenging for the end-user to route the splice point within the data center fiber management hardware. Additionally, these inline splice solutions are difficult to assemble, being best suited for factory assembly.

Accordingly, improved inline splice solutions are desired.

### BRIEF DESCRIPTION OF THE INVENTION

Aspects and advantages of the invention will be set forth in part in the following description, or may be obvious from the description, or may be learned through practice of the invention.

The present disclosure recognizes the foregoing considerations, and others, of the prior art, and provides improved inline splice solutions. Embodiments of the present disclosure provide apparatus and methods of assembly which substantially reduce the size of the currently commercially available inline splices while maintaining a mechanically robust mechanical package. Additionally, embodiments of the present invention may advantageously allow for possible field termination of transceiver modules.

According to one aspect, the present disclosure provides an optical fiber inline splice assembly comprising a first optical fiber cable which includes a first optical fiber having a first end and a second optical fiber cable which includes a second optical fiber having a second end. A splice sleeve assembly is also provided, in which the first end and the second end are optically spliced together. The splice sleeve assembly has a base and a lid matable with each other. The splice sleeve assembly further includes first and second end connecters removably attachable to the mated base and lid in order respectively to secure the first and second optical fiber cables thereto.

According to some preferred embodiments, the first and second end connectors may each be configured as a threaded cap engaging outer threads on the base and lid. The base may define a U-shaped channel in which the first and second optical fibers are seated. In addition, the base and lid may each preferably comprise an adhesive layer. For example, the adhesive layer of the base may be located substantially entirely in said U-shaped channel. Each of the threaded caps may capture strength member fibers of the first and second optical fiber cables. A heat shrunk sleeve in which the splice sleeve assembly is contained may also be provided.

According to another aspect, a splice sleeve assembly is provided for connecting a first end of a first optical fiber and a second end of a second optical fiber. The splice sleeve assembly includes a base, the base including a first end portion, a second end portion, and a mid-section disposed therebetween, the base defining a channel. The splice sleeve assembly further includes a lid, the lid including a first end portion, a second end portion, and a mid-section disposed therebetween. The splice sleeve assembly further includes a first adhesive layer and a second adhesive layer positionable between the base and the lid, the first adhesive layer positionable substantially entirely in the channel. The splice sleeve assembly further includes a first end connector attachable to the first end portion of the base and the first end portion of the lid, and a second end connector attachable to the second end portion of the base and the second end portion of the lid. The splice sleeve assembly further includes a heat shrink sleeve. The first end and the second end are positionable between the base and the lid and between the first adhesive layer and the second adhesive layer.

According to another aspect, the present disclosure provides a method of securing a first optical fiber cable having a first end and a second optical fiber cable having a second end in optically spliced relationship. One step of the method involves providing a splice sleeve assembly having a base and a lid matable with each other. The first end of the first optical fiber cable and the second end of the second optical fiber cable are positioned on the base of the splice sleeve assembly in optically spliced relationship. The lid is mated with the base. First and second end connecters are connected to the base and lid when mated with each other in order respectively to secure the first and second optical fiber cables to the base and lid.

According to another aspect, the present disclosure provides a method for connecting a first optical fiber cable and a second optical fiber cable. The first optical fiber cable includes a first optical fiber having a first end, and the second optical fiber cable includes a second optical fiber having a second end. The method includes exposing the first end from the first optical fiber cable and the second end from the second optical fiber cable, and splicing the first end and the second end together. The method further includes positioning the spliced-together first end and second end within a base of a splice sleeve assembly. The method further includes mating a lid of the splice sleeve assembly to the base after the spliced-together first end and second end are positioned on the base. The method further includes attaching a first end connector and second end connector to the base and the lid to secure the spliced-together first end and the second end within the splice sleeve assembly between the base and the lid.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a plan view of a representative transceiver module with a connectorized pigtail in accordance with embodiments of the present disclosure;

FIG. 2 is an isometric assembly view of an inline splice assembly in accordance with embodiments of the present disclosure;

FIG. 3 is a side assembly view of the inline splice assembly of FIG. 2;

FIG. 4 is a side partial cross sectional view of the inline splice assembly of FIG. 2;

FIG. 5A is a perspective view of a splice sleeve assembly of an inline splice assembly in accordance with embodiments of the present disclosure;

FIG. 5B illustrates the splice sleeve assembly of FIG. 5A with a splice lid removed for illustrative purposes;

FIG. 5C is a top plan view of the splice sleeve assembly of FIG. 5A;

FIG. 5D is an axial cross-sectional view of the splice sleeve assembly of FIG. 5A;

FIG. 5E is a transverse cross-sectional view of the splice sleeve assembly of FIG. 5A;

FIG. 6 is a side partial cross-sectional view of an inline splice assembly in accordance with embodiments of the present disclosure;

FIG. 7 is a side view of the inline splice assembly of FIG. 6;

FIG. 8 is a perspective view of an inline splice assembly, with the heat shrunk sleeve removed for illustrative purposes, in accordance with embodiments of the present disclosure;

FIG. 9 is a perspective sectional view of the inline splice assembly of FIG. 9;

FIG. 10 is a side cross-sectional view of an inline splice assembly in accordance with embodiments of the present disclosure;

FIG. 11 is a side cross-sectional view of an inline splice assembly in accordance with embodiments of the present disclosure;

FIG. 12 is a top view of components utilized to connect a first optical fiber cable and a second optical fiber cable in accordance with embodiments of the present disclosure; and

FIG. 13 is a perspective view of further components utilized to connect a first optical fiber cable and a second optical fiber cable in accordance with embodiments of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

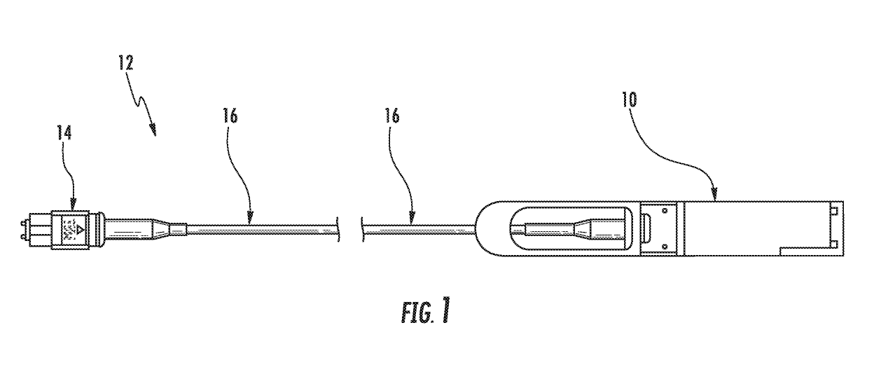

FIG. 1 illustrates a representative transceiver module 10 with a connectorized pigtail 12. In this case, a “QSFP” transceiver module package configuration is shown. One skilled in the art will appreciate, however, that embodiments of the present invention could also be applied to other module package types, such as “QSFP+” and “CXP.” In addition, the pigtail is in this example terminated with a MTP connector 14 as shown. As noted above, these pigtails typically range in length from 1 meter to 30 meters. Additionally, these pigtails could be terminated with multifiber connectors, such as the MTP or MPO connector, or fanned out into multiple single fiber connectors, such as the LC or SC connector. As shown, the module 10 and the pigtail 12 each include an optical fiber cable 16. As discussed herein, each optical fiber cable may include an outer jacket 18, inner strength member fibers (which may for example be aramid fibers), and one or more optical fibers.

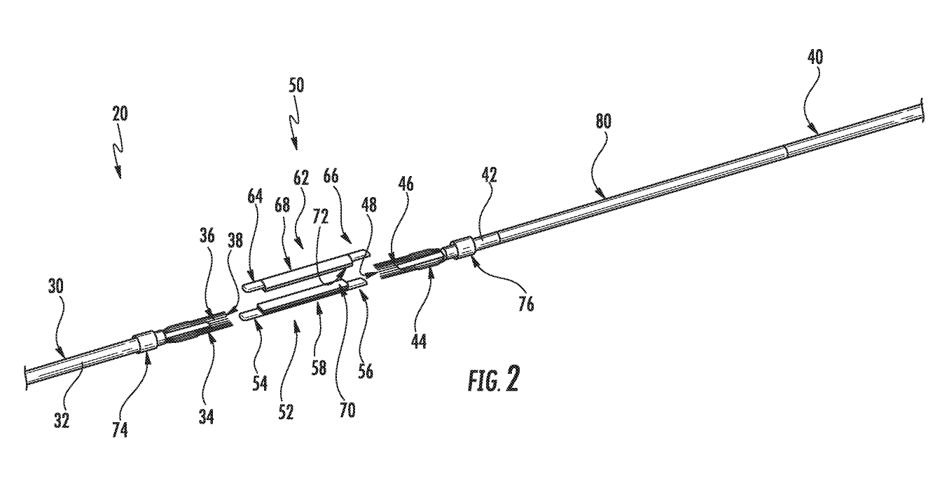

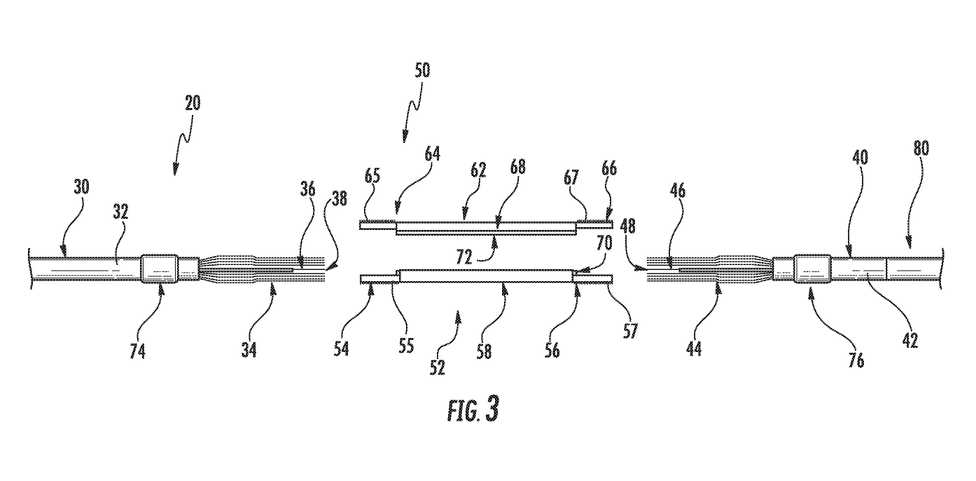

Referring now to FIGS. 2 and 3, an inline splice assembly 20 in accordance with the present disclosure is provided for joining two cable ends. The cable ends may, for example, be ends of cables 16 (FIG. 1). On the end of a first optical fiber cable 30, (left-hand side), a first end connector 74 (which may, for example, be a threaded cap having internal threads) is preloaded onto the cable end. The cable end is prepared for splicing using by removing a portion of the outer jacket 32 and cutting back the aramid (or other) strength member fibers 34. This exposes one or more first optical fibers 36 of the first cable 30, and specifically first ends 38 thereof. If the fiber optic cable 30 contains a fiber optic ribbon, the ribbon will be stripped and cleaved. If the fiber optic cable contains loose fibers, the loose fibers will then preferably be ribbonized, stripped and cleaved.

On the other cable end (right-hand side), i.e. the end of a second optical fiber cable 40, a first heat shrinkable sleeve 80 (as well as optionally, a second heat shrinkable sleeve 82 which may alternatively be preloaded on the end of the first optical fiber cable 30) and a second end connector 76 (which may, for example, be a threaded cap having internal threads) are preloaded onto the cable end. The cable end is prepared for splicing by removing a portion of the outer jacket 42 and cutting back the aramid (or other) strength member fibers 44. This exposes one or more second optical fibers 46 of the second cable 40, and specifically second ends 48 thereof. If the fiber optic cable 40 contains a fiber optic ribbon, the ribbon will be stripped and cleaved. If the fiber optic cable contains loose fibers, the loose fibers will then preferably be ribbonized, stripped and cleaved.

The first ends 38 and second ends 48 may be spliced together, i.e. via fusion splicing (such as mass fusion splicing) or laser fusion splicing. Such splicing connects each first end 38 to a respective second end 48, forming one or more spliced-together first and second ends.

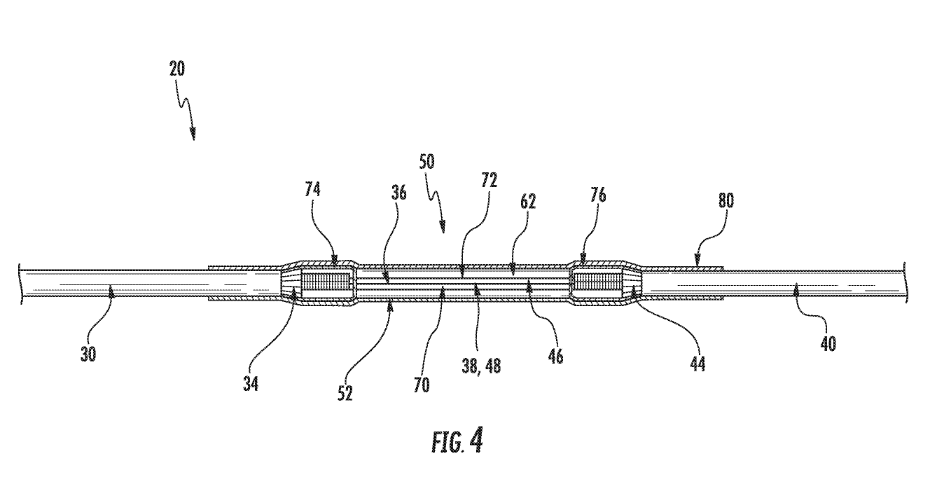

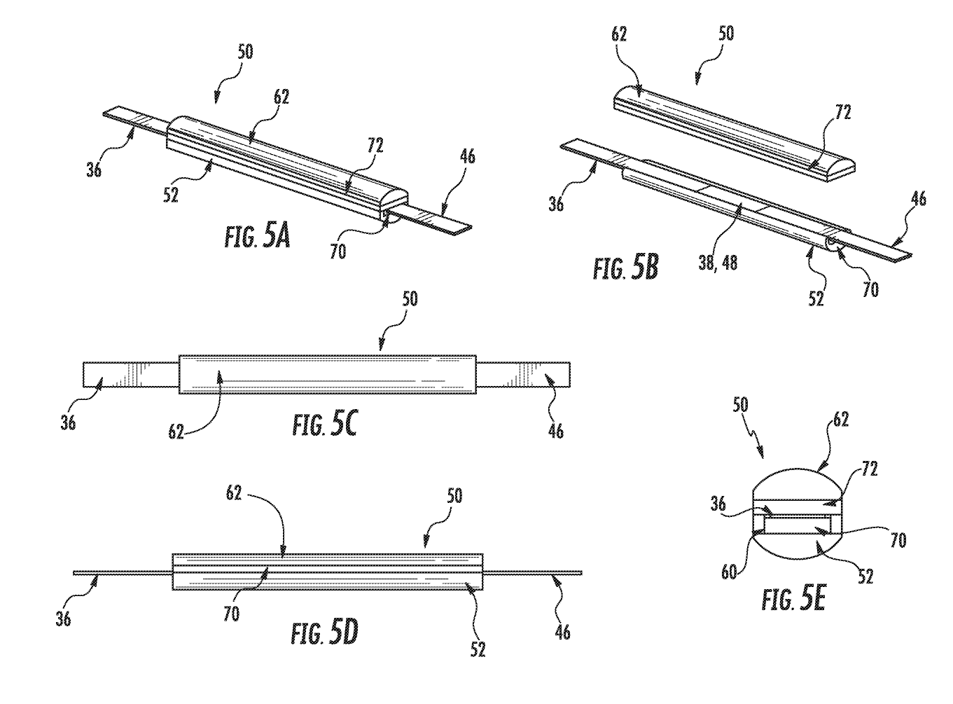

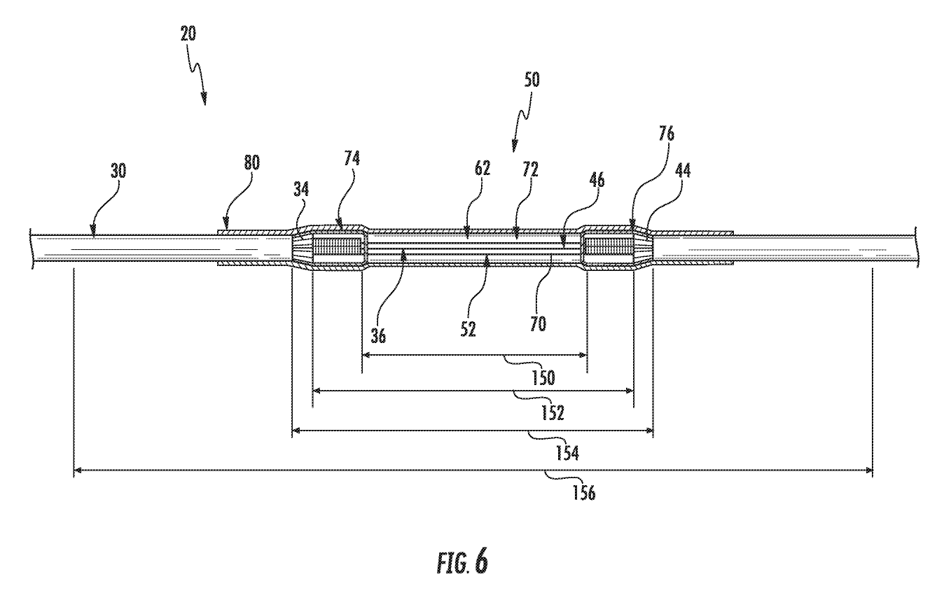

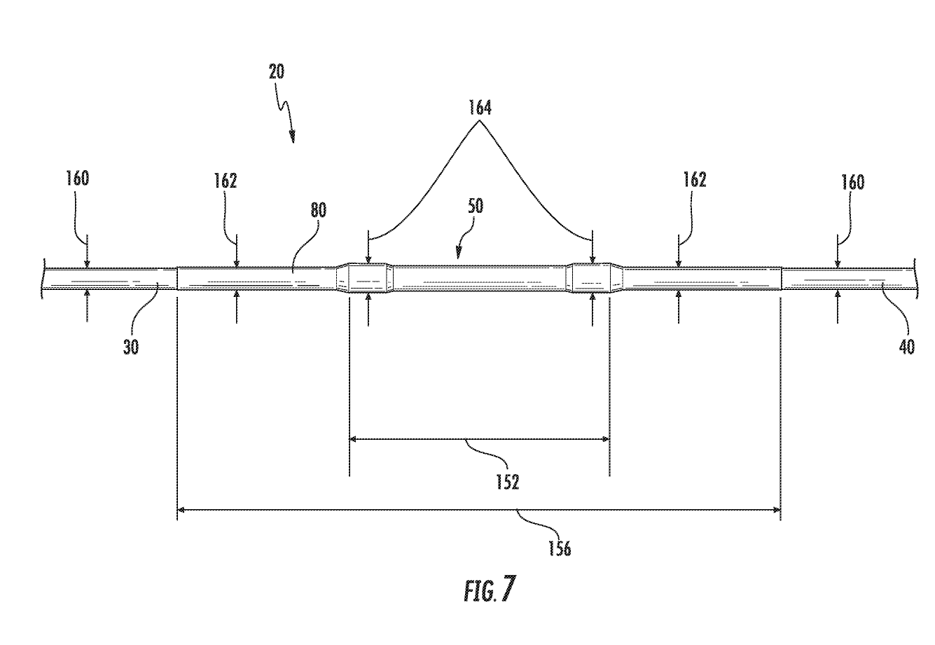

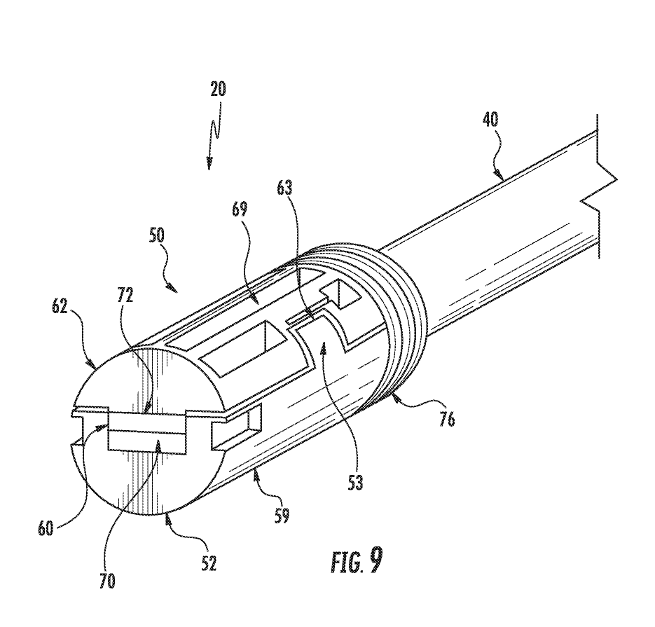

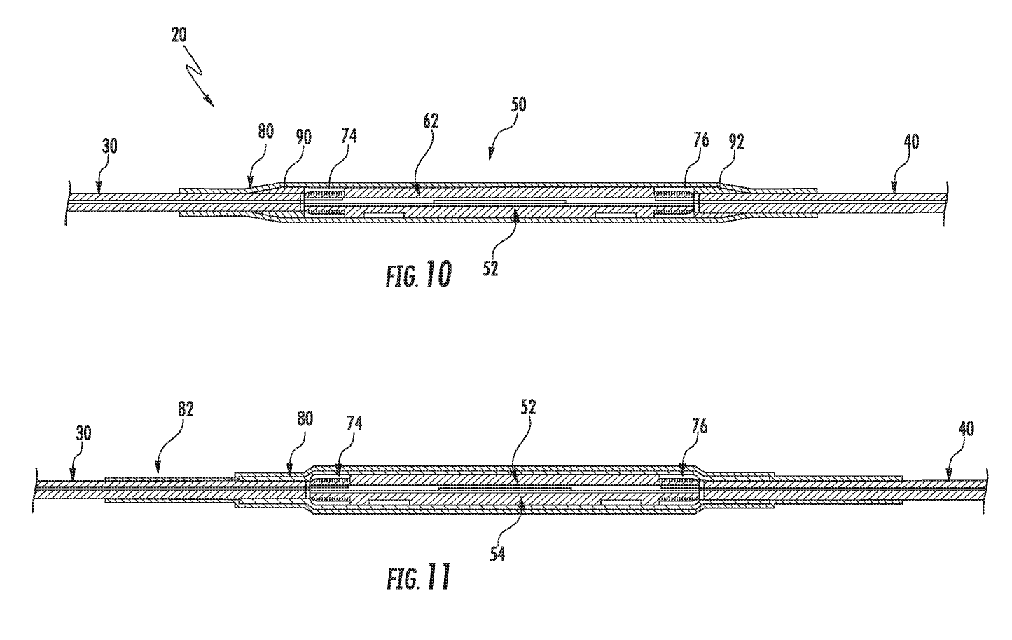

Referring now additionally to FIGS. 5A-5E, 8 and 9, splice sleeve assembly 50 may be used to protect the splice point(s) after the various first and second ends 38, 48 are spliced together. Splice sleeve assembly 50 may include a base 52. The base 52 may extend between a first end and a second end, and may include a first end portion 54 (which includes the first end), a second end portion 56 (which includes the second end), and a mid-section 58 between the first and second end portions 54, 56. The first and second end portions 54, 56 may, in exemplary embodiments, include outer threads 55, 57. The base 52 may have a generally arcuate cross-sectional shape. In some embodiments, as illustrated in FIGS. 2, 3 and 5A-5E, the mid-section 58 may have a solid outer surface. Alternatively, as illustrated in FIGS. 8 and 9, cut-outs 59 may be defined through the mid-section 58 to strengthen and reduce the weight of the base 52.

In exemplary embodiments as shown, base 52 may further define a channel 60, which may for example, be a U-shaped channel. The channel 60 may for example extend at least through the mid-section 58.

Splice sleeve assembly 50 may further include a lid 62. The lid 62 may extend between a first end and a second end, and may include a first end portion 64 (which includes the first end), a second end portion 66 (which includes the second end), and a mid-section 68 between the first and second end portions 64, 66. The first and second end portions 64, 66 may, in exemplary embodiments, include outer threads 65, 67. The lid 62 may have a generally arcuate cross-sectional shape. In some embodiments, as illustrated in FIGS. 2, 3 and 5A-5E, the mid-section 68 may have a solid outer surface. Alternatively, as illustrated in FIGS. 8 and 9, cut-outs 69 may be defined through the mid-section 68 to strengthen and reduce the weight of the lid 62.

Splice sleeve assembly 60 may further include a first adhesive layer 70 and a second adhesive layer 72. When assembled, the first adhesive layer 70 and second adhesive layer 72 may be disposed between the base 52 and lid 62. For example, the first adhesive layer 70 in exemplary embodiments may be disposed substantially entirely in the channel 60.

FIG. 4 illustrates a side cross-sectional view of the inline splice assembly 20 shown in FIGS. 2 and 3 in its assembled state. After the first and second ends 38, 48 are spliced together, the spliced-together ends 38, 48 (which in exemplary embodiments are ribbonized) are set on the base 52, such as seated within the channel 60. For example, the spliced-together ends 38, 48 may be set on top of first adhesive layer 70 in channel 60 of the base 52. The first adhesive layer 70 holds the spliced, ribbonized fibers in a rigid, planar orientation.

The lid 62 is then placed onto the base 52, thus mating the lid 62 and base 52 together. The second adhesive layer 72, disposed for example on the lid 62, bonds to the top surface of the spliced-together ends 38, 48 (which in exemplary embodiments are ribbonized), and may further bond to ridges of the base 52 defining the channel 60. (See FIG. 5E).

Various views of the splice sleeve assembly 50 are shown in FIGS. 5A through 5E. For clarity, these views of the splice sleeve assembly do not show the threads of the splice sleeve base and splice sleeve lid. The base 52 and lid 62 are preferably made of a thermally-stable plastic, such as Ultem 2300. As shown, in exemplary embodiments, the thickness of the first adhesive layer 70 is sized such that the first adhesive layer 70 is intentionally shallower than the ridges defining the channel 60 of the base 52, allowing the spliced, ribbonized optical fibers to sit partially below the plane formed by the ridge tops. The second adhesive layer 72 is preferably designed to bond to both ridges of the base 52 defining the channel 60.

Referring again briefly to FIGS. 8 and 9, in some embodiments latching assemblies may be utilized to mate the base 52 and lid 62 together. For example, base 52 (or lid 62) may include one or more male latches 53, and lid 62 (or base 52) may include one or more mating female receivers 63. The latches 53 and receivers 63 may, for example, be positioned on the mid-sections 58, 68. The latches 53 may latch onto the receivers 63 to mate the base 52 and lid 62 together.

Referring again to FIG. 4, the strength member fibers 34, 44 may be flared over, and thus for example uniformly distributed over, the end portions 54, 64 and 56, 66 respectively. Each end connector 74, 76, which may be removably attachable to the base 52 and lid 62, is attached to the base 52 and lid 62. For example, first end connector 74 is attached to the first end portions 54, 64, and the second end connector 76 is attached to the second end portions 56, 66. Such attachment in exemplary embodiments is a threaded attachment, wherein the inner threads of the connectors 74, 76 engage the outer threads 55, 65 and 57, 67. Portions of the strength member fibers 34, 44, by virtue of being flared over the base 52 and lid 62, may be captured by the first and second end connectors 74, 76, such as between the end connectors 74, 76 and the mated base 52 and lid 62. The end connectors 74, 76 are thus used to mechanically fasten the strength member fibers onto the end portions 54, 64, 56, 66, giving the assembly tensile and radial strength. (Notably, while a threaded connection is utilized in exemplary embodiments, one skilled in art will appreciate that various alternatives of securing the strength member fibers with respect to the splice sleeve assembly 50 may be utilized.)

Referring now to FIG. 10, in some embodiments, splice sleeve assembly 50 may further include a first boot 90 and a second boot 92. The first and second boots 90, 92 may, for example, be preloaded onto the first and second cables 30, 40, respectively. After attaching the end connectors 74, 76 to the splice sleeve assembly 50, the boots 90, 92 may be attached to the end connectors 74, 76.

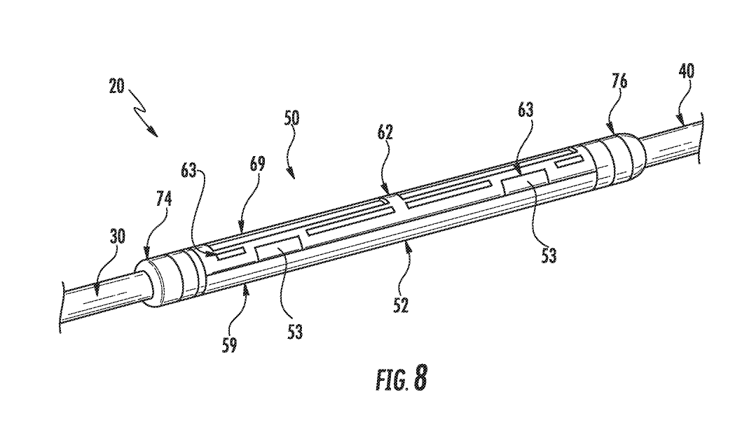

Referring now to FIG. 4 and FIGS. 6, 7, 10 and 11, after attaching the end connectors 74, 76 and optionally attaching the boots 90, 92 to the end connectors 74, 76, the first heat shrinkable sleeve 80 may then be slid up over the splice sleeve assembly 50, centered and shrunk. The resulting heat shrunk sleeve 80 surrounds the other components of the splice sleeve assembly 50. In particular, the heat shrunk sleeve 80 grips the base 52 and lid 62 and the cables 30, 40, providing a second layer of mechanical strength to the inline splice assembly 20. Additionally, the heat shrunk sleeve 80 provides water and humidity protection to the underlying components of the splice sleeve assembly 50.

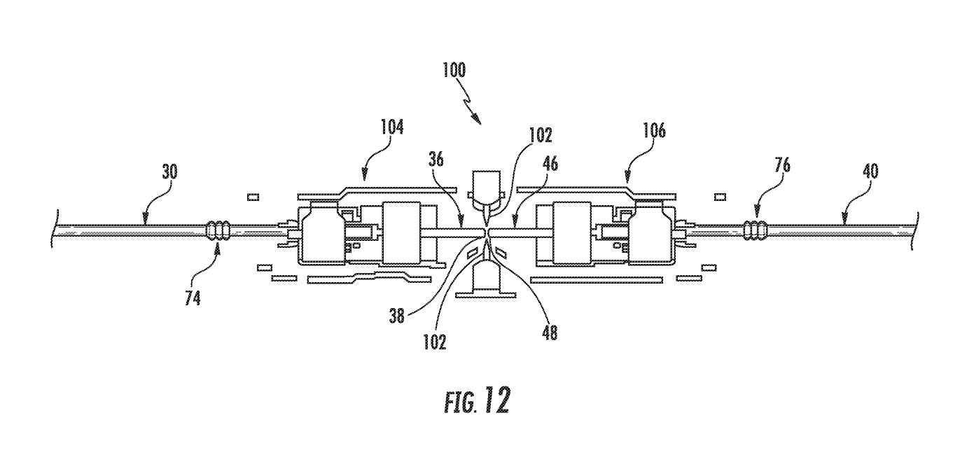

As illustrated in FIG. 11, in some embodiments a second heat shrinkable sleeve 82 may additionally be utilized. The second heat shrinkable sleeve 82 may be slid up over the other components of the splice sleeve assembly 50 including the first heat shrunk sleeve 80, centered and shrunk. The resulting heat shrunk sleeve 82 surrounds the other components of the splice sleeve assembly 50. In particular, the heat shrunk sleeve 82 provides a third layer of mechanical strength to the inline splice assembly 20. Additionally, the heat shrunk sleeve 82 provides further water and humidity protection to the underlying components of the splice sleeve assembly 50.

FIG. 7 shows the inline splice assembly 20 after shrinking of the heat shrinkable sheath 80. For aesthetics, the outer diameter of mid-sections 58, 68 may be increased so that the outer diameter of the end connectors 74, 76 and the outer diameter of the mid-sections 58, 68 are equal.

FIGS. 6 and 7 illustrate aspects of an exemplary 8F (fiber) inline splice assembly 20. In this example, the main body of the splice sleeve assembly 50 defined by mid-sections 58 and 68 has a length 150 of between 20 mm and 40 mm, such as between 25 mm and 35 mm, such as approximately 25 mm or approximately 30 mm. This length is driven by the following: (1) most commercially available mass fusion splicers require cleaved fibers to be 10 mm or longer; (2) for reliability, it is recommended that the main body overlaps the end of a splice optical fiber ribbon by 2 mm; and (3) an addition to the main body length to allow of placement accuracy of the spliced ribbon within the splice sleeve assembly 50.

As illustrated in FIG. 6, in this case, the stiff length 152 of the inline splice sleeve assembly 20 is between 30 mm and 60 mm, such as between 40 mm and 60 mm, such as approximately 35 mm or approximately 45 mm or approximately 50 mm, the length from one end connector to the other. This portion of the inline splice sleeve assembly 20 is not intended to significantly bend or flex. In addition, a small transition is required for the strength member fibers routed from the cut cable jackets to the splice sleeve lid and base end portions. This length 154 between transitions is between 40 mm and 80 mm, such as between 50 mm and 80 mm, such as approximately 40 mm or approximately 60 mm. Moreover, the heat shrink sleeve 80 overlaps the cable ends, making the total length 156 of the inline splice assembly 20 to be between 90 mm and 120 mm, such as approximately 90 mm or approximately 100 mm. In exemplary embodiments, the total length of the inline splice assembly 20 may be less than or equal to 100 mm.

Various exterior dimensions are shown in FIG. 7. Specifically, various maximum outer diameters of various components are illustrated. In this case, the cables 30, 40 may have maximum outer diameters 160 of between 2.7 mm and 3.3 mm, such as approximately 3.0 mm, the portion of the heat shrink sleeve 80 overlapping the cable 30, 40 may have a maximum outer diameter 162 of between 3.4 mm and 3.8 mm, such as approximately 3.6 mm, and the overall maximum outer diameter 166 of the assembly is between 4.0 mm and 4.4 mm, such as approximately 4.25 mm. In exemplary embodiments, an overall maximum outer diameter 166 of the assembly may be less than 5 millimeters.

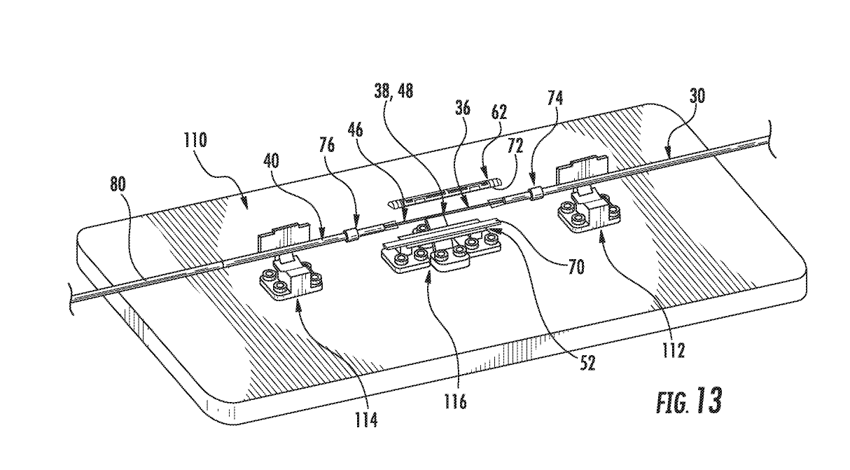

The present disclosure is further directed to methods for connecting a first optical fiber cable 30 and a second optical fiber cable 40. FIGS. 12 and 13 illustrated various apparatus for facilitating such connecting. For example, FIG. 12 illustrates an exemplary splicer 100, in this case a fusion splicer. The splicer 100 includes electrodes 102 which form an electrical arc for splicing ends 38, 48 together. Further, first and second clamp assemblies 104, 106, each of which includes one or more clamps, are provided. After preloading various components and exposing the first and second ends 38, 48 as discussed herein, the cables 30, 40 may be clamped into place in the splicer 100 via clamp assemblies 104, 106. The splicer 100 may then be operated to splice the ends 38, 48 together.

FIG. 13 illustrates an exemplary assembly jig 110 for assembling inline splice assembly 20 after initial splicing-together of the first ends 38 and second ends 48. The assembly jig 110 may include, for example, first and second clamp assemblies 112, 114, each of which includes one or more clamps. The cables 30, 40 may be clamped into place in the assembly jig 110 via clamp assemblies 112, 114. The assembly jig 110 may further include a seat 116 on which assembly of the splice sleeve assembly 50 may occur. For example, the base 52 may initially be placed on the seat 116, and the first adhesive layer 70 may additionally be provided. The spliced-together ends 38, 48 may then be provided on the base 52 as discussed herein. The lid 62 and second adhesive layer 72 may then be mated to the base 52 and first adhesive layer 70 and the spliced-together ends 38, 48 are secured therein. The end connectors 74, 76 may then be attached, the optional boots 90, 92 may be attached, and the sleeve 80 (and optional sleeve 82) may be provided to surround the other components of the assembly 50 and shrunk thereon to form the assembly 20.

The method for connecting the first and second cable 30, 40 may include, for example, exposing the first end(s) 38 and second end(s) 48 as discussed herein, and may further include splicing the first end(s) 38 and second end(s) 48 together as discussed herein.

Before such splicing (and in exemplary embodiments before such exposing), such method may further include preloading a first end connector 74 onto the first optical fiber cable 30 and preloading a second end connector 76 onto the second optical fiber cable 40, as discussed herein. Additionally, and before such splicing (and in exemplary embodiments before such exposing), such method may further include preloading the heat shrink sleeve(s) 80, 82 onto the first and/or second optical fiber cables 30, 40, as discussed herein.

Such method may further include, for example, the step of positioning the spliced-together first end(s) 38 and second end(s) 48 on base 52, as discussed herein. For example, the spliced-together first end(s) 38 and second end(s) 48 may be positioned in channel 60 and/or on first adhesive layer 70 (which may be disposed substantially entirely in channel 60), as discussed herein. Further, such method may include mating lid 62 to base 52 after the spliced-together first end(s) 38 and second end(s) 48 are positioned on the base 52, as discussed herein. In exemplary embodiments, second adhesive layer 72 is disposed between the lid 62 and the spliced-together first end(s) 38 and second end (48) after mating of the lid 62 to the base 52.

Such method may further include flaring strength member fibers 34, 44 of the first optical fiber cable 30 and the second optical fiber cable 40 over the base 52 and the lid 62, as discussed herein.

Such method may further include attaching first end connector 74 and second end connector 76 to the base 52 and lid 62 to secure the spliced-together first end(s) 38 and second end(s) 48 within the splice sleeve assembly 50 between the base 52 and the lid 62, as discussed herein. In exemplary embodiments, the first end connector 74 and second end connector 76 are each threaded caps, which engage outer threads 55, 57, 65, 67 of the base 52 and the lid 62, as discussed herein. In exemplary embodiments, he first end connector 74 captures the strength member fibers 34 of the first optical fiber cable 30 and the second end connector 76 captures strength member fibers 44 of the second optical fiber cable 40 when the first end connector 74 and second end connector 76 are attached to the base 52 and the lid 62, as discussed herein.

Such method may further include attaching a first boot 90 to the first end connector 74 and attaching a second boot 92 to the second end connector 76, as discussed herein.

Such method may further include surrounding the other components of the splice sleeve assembly 50 with the heat shrink sleeve 80, and applying heat to the heat shrink sleeve 80 to form a heat shrunk sleeve 80 as discussed herein. Such step may occur, for example, after attachment of the connectors 74, 76 and optional boots 90, 92. Such method may further include surrounding the other components of the splice sleeve assembly 50 with a second heat shrink sleeve 82, and applying heat to the heat shrink sleeve 82 to form a second heat shrunk sleeve 82 as discussed herein.

It can thus be seen that the present invention discloses a novel inline splice assembly for fiber optic cables. Preferred embodiments achieve one or more of the following benefits:

1. Compact form factor that is smaller than commercially available solutions.

2. A clam-shell style splice sleeve is used to reduce the overall inline splice solution length.

3. The splice sleeve assembly completely mechanically insulates the splice regions.

4. Provides two layers of mechanical protection. The threaded caps/strength member fibers provide the first layer of axial and radial strength. The heat shrink provides the second layer of axial and radial strength.

5. Provides two layers of environmental protection. The splice sleeve provides the first layer of environmental protection. The heat shrink provides the second layer of environmental protection.

6. The assembly method is similar to the method employed on field installable connectors. Field technicians would have the skill and equipment necessary to install the inline splice solution in the field.

7. The clam shell splice sleeve can be re-entered if needed for troubleshooting if one end of the pigtail is damaged and needs to be replaced in the field without changing out the entire cable assembly in the data center.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An optical fiber inline splice assembly comprising:
a first optical fiber cable, the first optical fiber cable comprising a first optical fiber having a first end;
a second optical fiber cable, the second optical fiber cable comprising a second optical fiber having a second end, wherein the first end and second end are optically spliced together;
a splice sleeve assembly, the splice sleeve assembly comprising a base and a lid mated with each other, the first end and the second end disposed within the splice sleeve assembly between the base and the lid, the splice sleeve assembly further comprising a first end connector and a second end connector, the first end connector and second end connector removably attached to the base and the lid to secure the first end and the second end within the splice sleeve assembly between the base and the lid.

2. The optical fiber inline splice assembly of claim 1, wherein the first end connector and second end connector are each threaded caps engaging outer threads of the base and the lid.

3. The optical fiber inline splice assembly of claim 1, wherein the first end connector captures strength member fibers of the first optical fiber cable and the second end connector captures strength member fibers of the second optical fiber cable.

4. The optical fiber inline splice assembly of claim 1, wherein the splice sleeve assembly further comprises a first adhesive layer and a second adhesive layer, the first adhesive layer and second adhesive layer disposed between the base and the lid.

5. The optical fiber inline splice assembly of claim 1, wherein a channel is defined in the base, and wherein the first end and the second end are seated in the channel.

6. The optical fiber inline splice assembly of claim 5, wherein the splice sleeve assembly further comprises a first adhesive layer and a second adhesive layer, the first adhesive layer and second adhesive layer disposed between the base and the lid, and wherein the first adhesive layer is disposed substantially entirely in the channel.

7. The optical fiber inline splice assembly of claim 1, wherein the splice sleeve assembly further comprises a heat shrunk sleeve surrounding the base, lid, first end connector and second end connector.

8. The optical fiber inline splice assembly of claim 1, wherein a maximum outer diameter of the optical fiber inline splice assembly is less than 5 millimeters.

9. The optical fiber inline splice assembly of claim 1, wherein the first optical fiber is a plurality of first optical fibers and the second optical fiber is a plurality of second optical fiber cables.

10. A splice sleeve assembly for connecting a first end of a first optical fiber and a second end of a second optical fiber, the splice sleeve assembly comprising:
a base, the base comprising a first end portion, a second end portion, and a mid-section disposed therebetween, the base defining a channel;
a lid, the lid comprising a first end portion, a second end portion, and a mid-section disposed therebetween;
a first adhesive layer and a second adhesive layer positionable between the base and the lid, the first adhesive layer positionable substantially entirely in the channel;
a first end connector attachable to the first end portion of the base and the first end portion of the lid;
a second end connector attachable to the second end portion of the base and the second end portion of the lid; and
a heat shrink sleeve,
wherein the first end and the second end are positionable between the base and the lid and between the first adhesive layer and the second adhesive layer.

11. A method for connecting a first optical fiber cable and a second optical fiber cable, the first optical fiber cable comprising a first optical fiber having a first end, the second optical fiber cable comprising a second optical fiber having a second end, the method comprising:
exposing the first end from the first optical fiber cable and the second end from the second optical fiber cable;
splicing the first end and the second end together;
positioning the spliced-together first end and second end on a base of a splice sleeve assembly;
mating a lid of the splice sleeve assembly to the base after the spliced-together first end and second end are positioned on the base; and
attaching a first end connector and second end connector to the base and the lid to secure the spliced-together first end and the second end within the splice sleeve assembly between the base and the lid.

12. The method of claim 11, further comprising:
surrounding the base, lid, first end connector and second end connector with a heat shrink sleeve; and
applying heat to the heat shrink sleeve.

13. The method of claim 12, further comprising preloading the heat shrink sleeve onto the second optical fiber cable before splicing the first end and the second end together.

14. The method of claim 11, further comprising preloading the first end connector onto the first optical fiber cable and preloading the second end connector onto the second optical fiber cable.

15. The method of claim 11, wherein the spliced-together first end and second end are positioned on a first adhesive layer on the base.

16. The method of claim 15, wherein the first adhesive layer is disposed substantially entirely in a channel defined in the base.

17. The method of claim 11, wherein a second adhesive layer is disposed between the lid and the spliced-together first end and second end after mating of the lid to the base.

18. The method of claim 11, wherein the first end connector and second end connector are each threaded caps, and wherein the attaching step comprising engaging outer threads of the base and the lid.

19. The method of claim 11, further comprising flaring strength member fibers of the first optical fiber cable and the second optical fiber cable over the base and the lid, and wherein the first end connector captures the strength member fibers of the first optical fiber cable and the second end connector captures strength member fibers of the second optical fiber cable when the first end connector and second end connector are attached to the base and the lid.

20. The method of claim 11, wherein the first optical fiber is a plurality of first optical fibers and the second optical fiber is a plurality of second optical fiber cables.
